(19) United States
(12) Patent Application Publication
(10) Pub. No.: US 2026/0289944 A1
(43) Pub. Date: Sep. 24, 2026

(54) Product Dispenser Status Inquiry System and Method

(71) Applicant: Kimberly-Clark Worldwide, Inc., Neenah, WI (US)

(72) Inventors: Stephen Becker, Cumming, GA (US); Vannarak DeMonteiro, Suwanee, GA (US); Reilly Howell, Atlanta, GA (US); Galdric Marcotte, Alpharetta, GA (US); Nehuen Beron, Neenah, WI (US)

(21) Appl. No.: 19/472,865

(22) PCT Filed: Apr. 5, 2024
(86) PCT No.: PCT/US2024/023184

§ 371 Date: Oct. 6, 2025

Related U.S. Application Data
(60) Provisional application No. 63/494,566, filed on Apr. 6, 2023.

(51) Int. Cl. G06V 10/20; A47K 5/12; A47K 10/22; A47K 10/32; G06Q 10/063; G06Q 10/20; G06T 7/73

(52) U.S. Cl. CPC G06V 10/255; A47K 5/12; A47K 10/22; A47K 10/32; G06Q 10/063; G06Q 10/20; G06T 7/73

(57) ABSTRACT

A method and system for accessing information regarding a condition of a consumable product dispenser in a washroom facility is provided. Each product dispenser contained in the washroom facility or in a plurality of facilities can include sensors for determining product levels, power levels, or operating conditions. A server system stores the conditions of each product dispenser. An image recognition application loaded onto a mobile device is configured to recognize a particular product dispenser from the plurality of dispensers and to access and communicate to a user the condition of the product dispenser stored on the server system. The method and system of the present disclosure not only simplifies obtaining information regarding a product dispenser but also does so without draining battery power from any of the product dispensers.

### CROSS-REFERENCE TO RELATED APPLICATION

The present application is related and has right of priority to U.S. Provisional Patent Application No. 63/494,566 filed on Apr. 6, 2023, which is incorporated by reference in its entireties for all purposes.

### BACKGROUND

With respect to typical workplace washroom facilities, such as those facilities in a manufacturing plant, health care facility, office building, and the like, maintenance of the facilities is generally assigned to a maintenance team member that visits the facility on a scheduled or periodic basis to refill dispensers and ensure the cleanliness of the facility. The same person or persons may be assigned responsibility for a multitude of washroom facilities within a building or business site.

In the past, the maintenance person had little to no knowledge of the condition of the facility, especially the fullness state of the dispensers, until actually entering the facility. In this regard, the maintenance person must be prepared for completely empty states of the dispensers in the various facilities they are responsible for. The refill supplies are generally not stocked in the washroom facilities, and the maintenance person must carry sufficient refill supplies for a “worst case scenario”, which can be an overly burdensome task depending on the number of facilities and types of dispensers.

It has also been found that significant product waste can be attributed to certain maintenance practices. For example, a towel dispenser may be one-third full when checked by a maintenance person. It is a common practice, however, to attempt to overstuff the dispenser with a full refill during a scheduled maintenance visit. This overstuffed condition often results in jamming of the dispenser or overuse of towels by the washroom patrons, for example when multiple towels are dispensed as a result of the overstuffed condition. If the dispenser has an overstuff-prevention device, it is also a practice to discard the remaining towels in the dispenser so that a new, full, refill can be loaded into the dispenser. Over time, such waste can be quite expensive for the building proprietor.

U.S. Patent Publication No. 2021/0279654 discloses a system and process in which product dispensers and multiple washroom facilities are configured with a sensor that detects a product level or amount condition of the product dispenser. The sensors are in communication with a monitoring station assigned to the washroom facility. A set of instructions unique to each of the washroom facilities is generated based upon the detected product level or amount conditions of the dispensers. With an identification system configured within each washroom facility, maintenance personnel that enter the washroom facility can be identified and provided with a unique set of instructions in a message via a mobile phone smart device or an audio or visual display device. The '654 application has provided great advances in the art and is incorporated herein by reference.

Further advancements and improvements, however, are still needed in communicating information to maintenance personnel regarding the state or condition of one or more consumable product dispensers in a plurality of washroom facilities. For example, when information is stored on a computer system at a monitoring station, accessing the information by the maintenance personnel is typically done digitally using, for instance, Bluetooth technology. Accessing the information, however, can create a power strain on the individual product dispenser and may also require complicated software or actions in order to effectuate a digital connection in providing status data to a mobile device. Consequently, a need currently exists for accessing stored information regarding a product dispenser while minimizing power drain and/or in a manner that is less complicated than past systems and methods.

### SUMMARY

A method and associated washroom system are presented incorporating aspects of the disclosure. The term “washroom” is used generically herein to encompass any manner of public, semi-public, or private facility visited by patrons to use sink or toilet facilities, bathing facilities, changing facilities, and so forth. Such facilities are also known as restrooms, toilet closets, public bathrooms, men's room, ladies' room, and the like. A typical public or semi-private washroom has a number of toilet facilities or urinals and sinks.

Although the present method and washroom system are particularly useful in an “away-from-home” public or semi-private environment, the system is not limited by scope of use. As used herein, the term “away-from-home” means a place or location where people congregate for various reasons or purposes that are outside the typical home. Examples of away-from-home locations include places of business, such as office buildings, office suites, retail stores, and warehouses, manufacturing facilities; schools; hospitals and other types of medical facilities; places of worship; hotels and motels; conference centers; sporting arenas; stadiums; and the like. The method and system are particularly well-suited for structures wherein multiple washroom facilities are provided for use of the building tenants or an industrial or manufacturing site wherein multiple site facilities are provided for a controlled populace. It should be appreciated though that the present washroom system and method may prove useful in a residential or private environment, and such uses are within the scope and spirit of the disclosure.

In accordance with aspects of the disclosure, a system and related method are provided for maintenance of a plurality of washroom facilities by maintenance personnel. Such maintenance personnel may be members of a janitorial service that has responsibility for upkeep, restocking, and cleanliness of the washroom facilities on a daily basis, or members of a building support staff, and so forth. Each of the washroom facilities has one or more consumable product dispensers that require periodic refill, such as paper product dispensers, soap dispensers, toilet tissue dispensers, and so forth.

In one aspect, the present disclosure is directed to a method of accessing information regarding a condition of a consumable product dispenser in a washroom facility. The method includes detecting a condition of one product dispenser that is part of a plurality of product dispensers in multiple washroom facilities. Each product dispenser is for dispensing a consumable product that requires periodic refill. The condition can comprise at least one of a product level, a power level, an operating condition, or combinations thereof. The method further includes storing the detected condition on a server system.

In accordance with the present disclosure, the method further includes placing a mobile device in proximity to one of the product dispensers and accessing an image recognition application. The image recognition application is configured to recognize the particular product dispenser from the plurality of dispensers and to access and communicate to a user the stored condition of the product dispenser.

The image recognition application can operate in various ways in accordance with the present disclosure. In one aspect, for instance, the image recognition application can be configured to recognize the shape of the product dispenser from optical data. For example, the product dispenser can include an exterior housing that is recognized by the image recognition application. In one aspect, the image recognition application is configured to identify and recognize a product dispenser without recognizing a barcode or a QR code applied to the dispenser.

In one aspect, the image recognition application can be configured to identify a type of product dispenser (e.g. a particular model of a paper towel dispenser) and also be configured to identify the location of the particular product dispenser. The location of the dispenser, for instance, can be detected using a global positioning system that is associated with the mobile device. Alternatively, the location of the product dispenser can be determined by identifying indicia within the washroom where the product dispenser is located.

In one aspect, the image recognition software accesses a camera, or any suitable optical sensor capable of image analysis, on the mobile device and recognizes the product dispenser from optical data, such as a photograph, picture, digital image, or video taken of the product dispenser within the washroom.

As described above, various different information regarding the particular product dispenser can be communicated to the user or maintenance personnel. For instance, the communication can include a set of instructions comprising expected refill requirements of the product dispenser based on current conditions or requirements in the washroom facility files. In one aspect, the message can include a set of instructions including dispenser refill instructions based on an anticipated usage of the washroom facility before a next scheduled visit by the maintenance personnel.

As described above, information regarding each product dispenser within the washroom facilities can be stored on a server system. The image recognition application can access the server system without in any way compromising the power requirements of the product dispenser itself. The server system, for instance, can comprise a cloud-based system which the mobile device can access wirelessly through, for instance, a wi-fi network or through cellular data. The condition of each product dispenser contained within the multiple washroom facilities, for instance, can all be stored on the cloud-based system and accessed by the image recognition application using the mobile device.

The present disclosure is also directed to a system for maintenance of a plurality of washroom facilities by maintenance personnel. The system includes one or more product dispensers within each of the washroom facilities that requires periodic refill of a consumable product. Each of the product dispensers can include at least one sensor that detects a condition of the product dispenser. For example, the condition can be a product level, a power level, or an operating condition. Each of the sensors can be in communication with a monitoring station assigned to the washroom facility. A server system can be configured to store the condition of each product dispenser and optionally generate a set of instructions unique to each of the product dispensers. In accordance with the present disclosure, the system can further include an image recognition application loaded onto a mobile device that is configured to recognize a particular product dispenser from the plurality of dispensers and to access the condition of the product dispenser stored on the server system.

As described above, the image recognition application can be configured to recognize a particular product dispenser based upon optical data, such as its overall shape or based upon a particular feature of the overall shape. In one aspect, the image recognition application can be configured to recognize a type of product dispenser based upon the shape of a housing and can also be configured to determine the location of the particular product dispenser from all of the other product dispensers contained in each of the washroom facilities.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a diagram view of a washroom facility incorporating a system and method in accordance with aspects of the present invention;

FIG. 2 is a flow diagram of one embodiment of a process according to the present disclosure; and

FIG. 3 is a component diagram view of certain control features of a system and method in accordance with the invention.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

As mentioned, in one aspect, the present disclosure relates to a method and system for maintenance of washroom facilities, particularly where maintenance personnel are required to periodically refill consumable product dispensers within the facilities, such as paper towel dispensers, soap dispensers, toilet tissue dispensers, and so forth. The maintenance personnel may be members of a janitorial service that has responsibility for upkeep, restocking, and cleanliness of the washroom facilities on a daily basis, or members of a building support staff, and so forth.

More particularly, the present disclosure is directed to a method and system for easily and conveniently supplying information to a maintenance personnel regarding the condition of a particular product dispenser that can be one of many product dispensers in many different washroom facilities and buildings that are being monitored simultaneously. In the past, in order to access a condition of a product dispenser, the product dispenser had to be examined manually or, if the condition was monitored electronically, required a digital connection to the particular product dispenser that may cause a power drain on the dispenser and may also require complicated software and/or firmware. According to the present disclosure, however, an image recognition application is loaded on a mobile device in accordance with the present disclosure for scanning a particular product dispenser which causes the mobile application to obtain the most recent status information of the device or washroom from a wireless connection to, for instance, a cloud platform. The image recognition application, for instance, is configured not only to recognize the particular type of product dispenser but also the location of the dispenser for communicating the condition of the particular dispenser to the user without having to make a digital connection to the dispenser itself. Although the information can be obtained using a barcode or a QR code applied to the dispenser, alternatively, the image recognition application can identify the product dispenser from other indicia, including the shape of the dispenser housing or a particular feature on the dispenser housing. In one aspect, augmented reality tools or artificial intelligence can be used in order to recognize or determine the particular product dispenser for which information is requested.

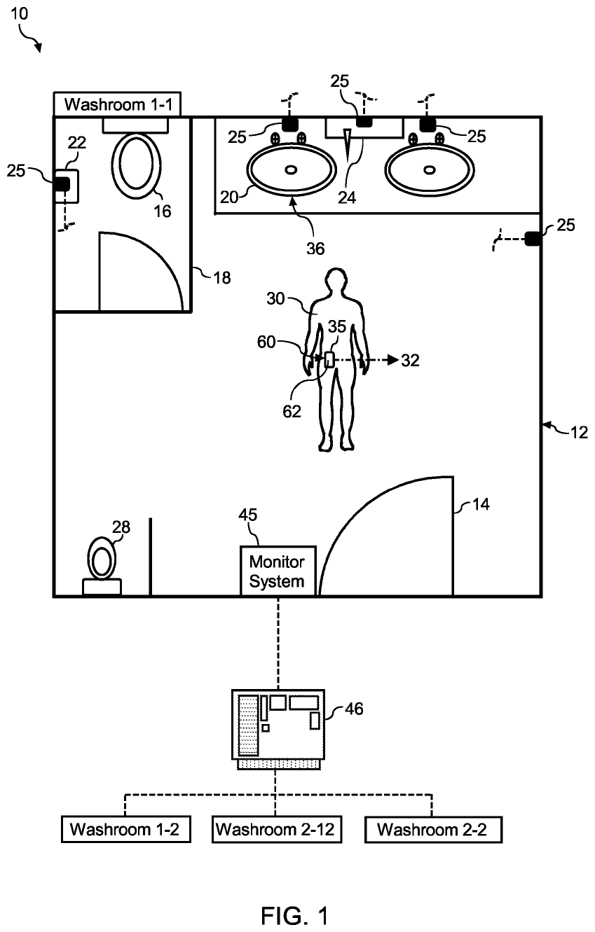

Referring to FIG. 1, an embodiment of a system and related method 10 are illustrated with respect to a public or semi-private washroom facility 12 within a building or business site location. The building may have a plurality of similarly configured facilities 12 on one or multiple floors. In addition to having multiple facilities 12 in a single building or at a single site location, the system and method of the present disclosure is also applicable to monitoring a plurality of facilities in multiple buildings.

The design and features of the washroom facility 12 depicted in FIG. 1 are for illustrative purposes only. The washroom facility 12 is depicted as a men's restroom facility having one or more individual stalls 18 (with individual toilets 16) and one or more urinals 28. A number of sinks 20 are also provided. Any combination of other conventional washroom components may also be provided in the washroom facility 12, such as toilet tissue dispensers 22, soap dispenser 24, towel dispenser 26, and so forth. The individual stalls 18, urinals 28, and sinks 20, may be considered as “functional locations” 36 wherein patrons may perform a desired washroom function within the facility 12. It should be appreciated that any manner of additional functional locations 36 may also be included in the washroom facility 12, such as shower stalls, dressing rooms, infant changing stations, and so forth.

FIG. 1 depicts a maintenance personnel 30 in the washroom facility 12. This person has responsibility for ensuring that the various product dispensers 22, 24, 26 are operable and filled, and for the overall cleanliness of the facility 12.

Within each washroom facility 12, the product dispensers 22, 24, 26 are configured with at least one sensor 25 that detects at least one condition of the product dispensers 22, 24, and 26. For instance, one or more sensors 25 can be used to detect a level or amount condition of the product in the dispenser based on any number of operational principles, such as run time of the dispenser or direct measurement of the amount of product dispensed. In addition to product levels, the one or more sensors 25 can also monitor various other conditions. For instance, the one or more sensors 25 can monitor power levels within each product dispenser when the product dispenser operates on battery power or has backup battery packs. The condition monitored by the sensors can also be an operating condition. The operating condition, for instance, can be related to whether there is a product jam or other malfunction. The operating condition can also be related to wear of the parts, especially the moveable parts, within the product dispenser. For instance, the condition can be whether or not various parts within the dispenser have reached their operating lifetime and need to be replaced.

The product dispensers 22, 24, 26 are in communication with a monitoring system 45 via any manner of suitable wireless communication system (as indicated by the dashed lines in FIG. 1). The monitoring system 45 is a computer-implemented system that may be remotely located from the washroom facility 12 or configured within the facility 12. The monitoring system 45 may monitor a number of similarly configured washroom facilities 12 within a building or business site location or within multiple building or sites. The monitoring system 45 may be in direct communication with a system server 46. Information from the monitor system 45 may be used by the server system to generate the set of instructions and messages delivered to the maintenance personnel 30 that are unique to each of the washroom facilities 12 or product dispenser based upon a detected product level or other condition of the dispensers 22, 24, 26 in the respective washroom facility 12.

In the embodiment of FIG. 1, the instructions 32 are delivered to the maintenance personnel 30 via a mobile device 35 carried by the person 30, such as a smart phone, tablet, PDA, smart glasses, or other network-enabled device (all referred to herein generically as a “mobile device”). The instructions 32 may be delivered in the form of text messages, emails, voice messages, or any other format supported by the mobile device 35 including the device accessing and displaying data from a central server system 46. The instructions 32 can be information related to the condition of a particular product dispenser. The communication 32, for instance, can be that no service is needed, that the dispenser needs product added, that there is a malfunction in the operation of the dispenser, the current status, condition, or product level of the dispenser, and/or a forecast when dispenser maintenance or product refill may be required.

The central server system 46 is in communication with the all of the product dispensers and includes a memory or library with a respective file, or data repository associated with each of the product dispensers, wherein the system 46 retrieves, accesses or opens the stored file or data repository associated with the product dispensers to generate the appropriate instruction messages 32 or communications as a function of the updated status of the various dispensers 22, 24, 26 in the identified washroom facility 12 relayed by the monitor system 45. The respective washroom facility file may also include any type of other relevant information, such as complaints, comments, or other conditions that were logged or otherwise entered into the server system 46 from any source. The files may contain information on events or activities in the building that may affect future washroom usage, wherein such information may be automatically or manually entered into the server system 46 from any source, such as from an electronic schedule or calendar maintained by the building supervisor that is automatically imported into the server system 46 on a regular basis.

Each of the washroom facilities 12 is equipped with wireless communication capability for communicating with the mobile device 35 carried or worn by the user 30. In accordance with the present disclosure, for instance, the mobile device 35 can include software and/or firmware that allows the device to receive communications from the server system 46. As will be described in greater detail below, the present disclosure is directed to a more efficient manner of placing the user 30 in communication with the server system 46 for obtaining information regarding a particular product dispenser located within one of the washroom facilities.

As mentioned, certain embodiments will have multiple washroom facilities 12 within a single building or multiple buildings linked to one or more central server systems 46 and one or more monitoring systems 45, with each product dispenser within the multiple of washroom facilities 12 in communication with the systems 45, 46. In this regard, a communications network is configured for these functions, wherein the individual dispensers are considered as network-enabled devices that may be directly connected to the network through a plurality of direct network links, thereby eliminating the need for the bus, router, or other networking equipment. It should also be appreciated that each of the network enabled devices (or a group of such devices) in this configuration may represent a node that, in turn, may be directly connected and/or multiplexed to the network via the direct network links. Further, the direct network links may represent secure communications channels physically hardened against tampering and/or the communications may be encrypted to prevent unauthorized access to information transmitted thereon.

The central server system 46 (which may be integrated with a monitoring system 45) may include a host computer, which may be an integrated server, or include any manner of periphery server or other hardware structure. The central processor system 46 may be a single networked computer, or a series of interconnected computers having access to the network via a gateway or other known networking system. Generally, the central server system 46 may include a central controller configured to manage, execute and control the individual terminal dispenser units, and to interface with the network enabled broadcast devices for retrieval/generation and play of the personalized messages described herein. The central server may include a memory for storing reward program procedures and routines, a microprocessor (MP) for executing the stored programs, a random access memory (RAM) and an input/output (I/O) bus. These devices may be multiplexed together via a common bus, or may each be directly connected via dedicated communications lines, depending on the needs of the system 10.

The central server system may be directly or indirectly connected through the I/O bus to any manner of peripheral devices such as storage devices, wireless adaptors, printers, and the like. In addition, a database (DB) may be communicatively connected to the central server and provide a data repository for the storage and correlation of information gathered from the individual dispenser units, receivers, display devices, or nodes of such devices.

It should be appreciated that the network-enabled devices (e.g., the individual dispenser units and/or display devices) may include similar features or may be configured with functionality to allow for an exchange of information required to function as described herein. The network-enabled devices may include a number of internal components, such as a controller having a program memory, a microcontroller or microprocessor (MP), a random access memory (RAM), and an input/output (I/O) bus, all of which may be interconnected via an address or data bus. The server system may include multiple, and even redundant, program memories and random access memories to increase expandability, capacity and/or processing speed.

The program memory and random access memory may be implemented as a solid-state memory, an integrated circuit, a magnetically readable memory, and/or optically readable memories. Further, the program memory may be read only memory (ROM) or may be read/write memory such as a hard disk. In the event that a hard disk is used as the program memory, the data bus may comprise multiple address/data buses, which may be of differing types, and there may be a separate I/O circuit between the data buses.

Network-enabled devices may be distributed throughout a single business establishment and connected with a LAN, or throughout multiple sites and connected with a WAN. Further, the LAN and/or WAN connecting each of the devices may include one or more separate and secure buses, routers, web servers, gateways and other networking equipment to provide continuous and/or redundant connectivity to the network.

In the past, in order to communicate with a user 30 regarding a condition of one of the product dispensers 22, 24, or 26, relatively complex connections and multiple hardware devices were used including display screens, identification badges, and/or audio accessories. In one aspect, the product dispenser may also include a digital screen for communicating with users, such as maintenance personnel. These past methods were not only complex but also may cause a power drain, especially for product dispensers operating on battery power.

In accordance with the present disclosure, the mobile device 35 can include a system for shape/object recognition using still/scan/moving image optical digital media processing. For instance, in one aspect, the mobile device 35 can include an image recognition application 60 that makes a secure and possibly crypted connection with the server system 46 for receiving information regarding any particular product dispenser. For example, the mobile device 35 can include an image capturing device 62 that is accessed by the image recognition application 60 for communicating an image of a product dispenser to the server system 46. The server system 46, in turn, is configured to recognize the image and determine the particular product dispenser that is the subject in the image and to communicate with the user 30 one or more conditions regarding the product dispenser.

The image recognition application 60 contained or loaded onto the mobile device 35 can be any suitable image recognition processor that is capable of analyzing optical images for identifying two-dimensional or three-dimensional structures. Examples of shape or object recognition systems, for instance, are disclosed in U.S. Patent Publication No. 2017/0249491, U.S. Patent Publication No. 2018/0075681, U.S. Pat. No. 9,129,277, and U.S. Pat. No. 10,095,030, which are all incorporated herein by reference.

In FIG. 1, the implementation of the system and method of the present disclosure can include a mobile device 35 that contains an image recognition application 60 in communication with a cloud/server 46. The image recognition application 60 can be solely installed on the mobile device 35, solely installed on the server system 46, or can include software that is installed on both the mobile device 35 and the server system 46.

As described above, the mobile device 35 can include a personal computer, a mobile phone, a tablet, a video camera, smart glasses, or any other device capable of capturing digital images, such as videos and pictures, or controlling a peripheral device to capture videos and pictures. FIG. 1 only shows a single mobile device 35 communicating with one cloud/server system 46. It should be understood, however, that the present disclosure is not limited to the implementation of FIG. 1. For example, in other implementations, there may be any number of user devices in communication with cloud and server systems.

The mobile device 35 includes some type of method or component for receiving and communicating information to the user. The mobile device 35 may include, for example, a keyboard, a mouse, a game controller, a touch screen input, a thermal and/or electrical sensor, microphone, or any other component for accepting user input. The mobile device may include a display that comprises a liquid crystal display screen built into the device. In other embodiments the mobile device may include a display that projects images onto a surface such as the lens on glasses or other visual surface.

In one embodiment, the mobile device 35 can include one or more processors and memory. The processor can be configured to access the memory to store received input or to execute commands, processes, or programs stored in memory, such as the image recognition application 60. The processor may correspond to a processing device, such as a microprocessor or similar hardware processing device, or a plurality of hardware devices. The memory can be capable of storing commands, processes and programs for execution by the processor. The memory may be instituted as ROM, RAM, flash memory, or any sufficient memory capable of storing a set of commands.

The server system 46 may also include one or more processors and memory which may be similar to the processor and memory of the mobile device 35. The server system 46 may be configured to store received input and to execute commands, processes or programs stored in memory, such as a recognition software application. Furthermore, the memory may be capable of storing commands, processes, and programs for execution by the processor. The memory is also configured to store images or other information received from the mobile device 35.

As described above, the mobile device 35 includes an image recognition application 60 and an image capturing device 62. The image capturing device 62 is for capturing optical data using, for instance, any suitable optical sensor. The optical data can include a still image, a video, a data stream, a series of still images, a panorama, or any other type of optical data that can be captured and communicated to the server 46. The image capturing device 62, for instance, can be a camera, a video camera, or any other suitable device for capturing optical data. In one aspect, the image capturing device 62 is built into the mobile device 35. It should be understood, however, that the image capturing device 62 can be a different component than the mobile device 35.

In accordance with the present disclosure, the image capturing device 62 is used to capture optical data corresponding to one of the product dispensers 22, 24 or 26 contained within the washroom facility 12. As described above, the optical data can be a picture or photograph, a video, or the like. The optical data captured by the image capturing device 62 is communicated to or accessed by the image recognition application 60 and communicated to the server 46. The server system 46 includes memory that contains reference data, and particularly reference optical data. The server system 46, for instance, can be configured to compare the optical data received from the image recognition application 60 and to reference data for determining the type of product dispenser for which the user 30 is requesting information. In one implementation, the server system 46 can use the reference data to not only determine the type of product dispenser but to also recognize the particular product dispenser and/or the location where the product dispenser is positioned within the washroom facilities that are being monitored. Once the particular product dispenser is recognized by, for instance, software contained in the server system 46, the current condition of the product dispenser can be communicated back to the mobile device 35 and accessed by the user 30.

For example, in one aspect, the image capturing device 62 is operated by the user or maintenance personnel to obtain optical data regarding one of the product dispensers. The optical data is then transmitted to the server system 46, which can be a cloud-based system. The server system 46 can then use recognition software to determine the particular product dispenser for which the user wishes to obtain information. In one aspect, the optical data is not processed or in any way manipulated or changed on the mobile device 35 and is sent to the server system 46 as raw data. Alternatively, the image recognition application 60 on the mobile device 35 may use filtering or recognition software prior to sending the optical data to the server system 46. In this embodiment, the optical data can be changed or manipulated or can be sent to the server system 46 with other information.

In one implementation, the optical data captured by the image capturing device 62 and communicated to the server system 46 can be communicated to the server system with other information. The other information, for instance, can be a time when the optical data was captured and any information regarding the location of the product dispenser. The optical data may also include the identity of the user or maintenance personnel 30. This information can be combined with the optical data by the image recognition application 60. This information can be used for determining the location of the product dispenser and for identifying the maintenance personnel. A time stamp on the optical data also can be processed by the server system 46 so that any information regarding the condition of the product dispenser is communicated to the maintenance personnel 30 close in time to when the information was requested.

The optical data that is communicated to the server system 46 by the image recognition application 60 can, in one embodiment, comprise a picture or video of the shape of the product dispenser. For instance, the optical data can include the shape of the exterior housing of the product dispenser or can include a portion of the shape of the exterior housing of the product dispenser. The optical data can also include other indicia including the background mounting scene or any other information that may reveal the location of the product dispenser. In one aspect, the image capturing device 62 may be used to recognize a barcode or a QR code on the particular product dispenser for identifying the dispenser and its location. In an alternative implementation, however, no QR codes or barcodes are used in identifying the particular product dispenser thus eliminating the need to label every product dispenser in multiple facilities with barcodes and QR codes. Instead, the image recognition software can include augmented reality tools that can identify product dispensers by their shape, by a portion of their shape, or by other features of the dispenser.

The optical data created by the image capturing device 62 is processed by the image recognition application 60. As described above, the image recognition application 60 can be contained solely on the mobile device or can partially be on the mobile device 35 and partially on the server system 46. In one implementation, the optical data is fed to a comparing module to compare the optical data with reference data. The comparing module matches the optical data with reference data to identify the particular product dispenser. For instance, the product dispenser can be the toilet tissue dispenser 22, the soap dispenser 24, or the towel dispenser 26. In order to identify and recognize a particular product dispenser, the dispenser type should be recognized in conjunction with the location of the dispenser and optionally the model number or model year of the dispenser. Determining the location of the particular product dispenser, for instance, may be needed when monitoring large facilities or multiple buildings that contain a plurality of the same product dispenser.

The location of the product dispenser can be determined using any suitable method or technique. For example, in one embodiment, the optical data that is sent to the comparing module may also include some indicia regarding the location of the product dispenser. Alternatively, the mobile device 35 may be in communication with a global positioning system (GPS). In this implementation, the optical data can be transmitted to the image recognition application containing the comparing module in conjunction with location coordinates determined by GPS.

In another aspect, the location of the product dispenser can be determined by monitoring the location of the maintenance personnel 30. For instance, the maintenance personnel 30 can carry an electronic ID badge, which may be integrated into the mobile device 35. Receivers can be installed in each of the washroom facilities that can sense the ID badge and transmit that information to the server system 46 for determining the location of the maintenance personnel 30. The location of the product dispenser can then be determined based upon the location of the maintenance personnel 30. In an alternative embodiment, however, the system and method of the present disclosure can operate without having to monitor the location of the maintenance personnel or without having to require the maintenance personnel to wear or carry any type of electronic identification badge.

Once the particular product dispenser has been recognized by the image recognition application 60, information stored in memory on the server system 46 can be communicated to the user or maintenance personnel 30 via the mobile device 35. The information can be communicated to the user or maintenance personnel 30 via visual, audio, or both. In one implementation, for instance, the condition of the product dispenser and any other information can be communicated to the maintenance personnel 30 as a written communication appearing on the display screen of the mobile device 35. The information can be communicated to the maintenance personnel 30 within the image recognition application 60 for maintaining the information secure. As explained above, the information communicated to the maintenance personnel 30 can include any one of: the product level contained within the product dispenser, the power level of the product dispenser, and/or any operating conditions that should be communicated to the maintenance personnel 30. In one aspect, the message or information communicated to the maintenance personnel 30 may be that the product dispenser contains product and is fully operational and that no service is required. In another aspect, the message or information communicated to the maintenance personnel 30 may be indicative of the current status, product level or condition of the product dispenser.

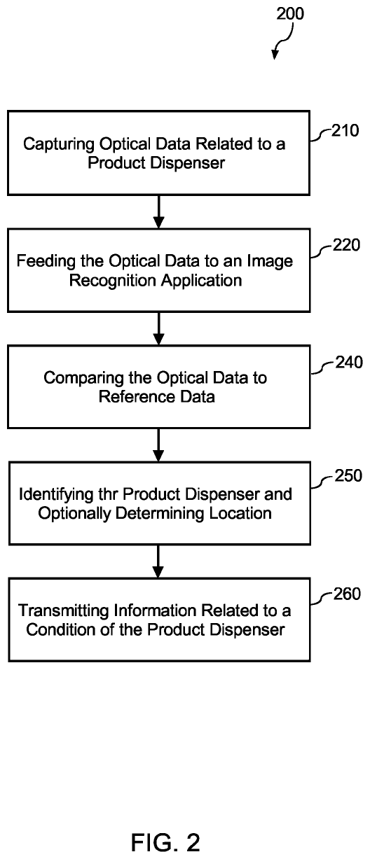

Referring to FIG. 2, one embodiment or implementation of the method of the present disclosure for providing to a user information regarding a condition of a product dispenser is shown.

As illustrated in FIG. 2, the flow chart includes a step of first capturing optical data relating to a product dispenser 210. In one aspect, for instance, the user can access a camera on the mobile device 35 and take a picture or video of the product dispenser 22, 24, or 26 for which information is desired. This optical data can then be fed to an image recognition application 220. The image recognition application 220 can operate on the mobile device 35 in conjunction with the server system 46. In one embodiment, the image recognition application 60 includes a comparing module that compares the optical data to reference data 240 as shown in FIG. 2. The reference data, for instance, can be located in the memory or library 52 of the server system 46. From the optical data, the image recognition application is capable of identifying the product dispenser and optionally determining the location of the product dispenser 250. In one embodiment, the optical data provides enough information for the particular product dispenser to be recognized along with its location. Alternatively, the optical data is provided for recognizing the particular type of product dispenser and other information is used to determine location. For instance, the mobile device 35 can be in communication with a global positioning system for determining the location of the product dispenser. In this manner, the method can identify the particular type of product dispenser and the exact location of the product dispenser within the facilities being monitored by the system.

Once the particular product dispenser is identified as shown in FIG. 2, information related to a condition of the product dispenser is transmitted 260 to the user or maintenance personnel 30. The information, for instance, may include the level of product remaining in the product dispenser and can optionally include instructions as to when further product should be added to the product dispenser.

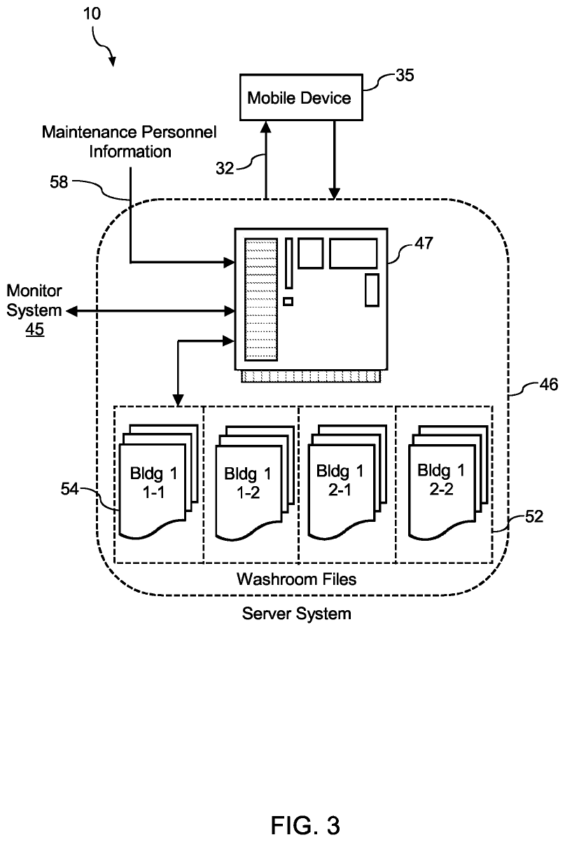

FIG. 3 is a schematic illustration of certain control aspects of a system 10 in accordance with the invention. In this particular system 10, the server system 46 includes any manner of computer-implemented server 47. The system 46 includes a library 52 in which the washroom facility files 54 are stored. Each file 54 is associated with a particular washroom facility. As described above, each file 54 can include reference data for identifying the particular product dispensers.

As shown in FIG. 3, the mobile device 35 is configured to communicate with the server system 46 typically through a wireless network. The mobile device can include an image capturing device 62 for transmitting optical data to the server system 46. The entire system 10 can also include an image recognition application for identifying particular product dispensers once optical data is received related to the dispenser. Once a product dispenser is identified, the server system 46 can communicate information 32 to the mobile device 35 that can be related to the condition of the product dispenser, such as current product levels within the dispenser.

In one aspect, the server system 46 can also be configured to receive information 58 regarding the maintenance personnel. The information 58 can be related to the identity of the particular maintenance personnel, their shift times, and the like. As described above, in one embodiment, the maintenance personnel 30 may carry an ID badge that sends signals to the server system 46 indicating the location of the maintenance personnel.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1. A method of accessing information regarding a condition of a consumable product dispenser in a washroom facility comprising:
detecting a condition of a plurality of product dispensers in multiple washroom facilities, each product dispenser being configured to dispense a consumable product that requires periodic refilling, the condition comprising at least one of a product level, a power level, an operational condition, or combinations thereof;
storing washroom facility files on a server system, each of the washroom facility files being associated with a particular washroom facility of the multiple washroom facilities, the one or more washroom facility files including information regarding the condition of the product dispensers; and
placing a mobile device in proximity to one of the product dispensers and accessing an image recognition application, the image recognition application being configured to recognize the particular product dispenser from the plurality of dispensers and to access and communicate to a user the stored condition of the product dispenser.

2. A method as defined in claim 1, wherein the image recognition application recognizes a product dispenser by a shape of the product dispenser.

3. A method as defined in claim 1, wherein the image recognition application is configured to recognize the particular product dispenser by determining a location of the product dispenser.

4. A method as defined in claim 1, wherein the image recognition application is configured to recognize the particular product dispenser by determining a location of the product dispenser and a type of the product dispenser.

5. A method as defined in claim 3, wherein the location of the product dispenser is determined by a global positioning system in communication with the mobile device.

6. A method as defined in claim 3, wherein the location of the product dispenser is determined by identifying indicia within the washroom where the product dispenser is located.

7. A method as defined in claim 1, wherein the product dispenser includes an exterior housing and wherein the image recognition application recognizes the particular product dispenser by a shape of the exterior housing.

8. A method as defined in claim 1, wherein the image recognition application accesses a camera on the mobile device and recognizes the particular product dispenser from optical data related to the product dispenser.

9. A method as defined in claim 1, wherein the stored condition communicated to the user comprises expected refill requirements of the particular product dispenser.

10. A method as defined in claim 1, wherein the stored condition communicated to the user comprises product dispenser refill instructions based on an anticipated usage of the washroom.

11. A method as defined in claim 1, wherein the stored condition communicated to the user comprises product dispenser instructions indicative of the product level remaining in the product dispenser.

12. A method as defined in claim 1, wherein the stored condition of the product dispenser is communicated to the user via the mobile device displaying said stored condition based on data from the server accessed by said mobile device

13. A method as defined in claim 1, wherein the image recognition application is in communication with the server system for receiving the stored condition of the product dispenser.

14. A method as defined in claim 11, wherein the server system comprises a cloud-based system.

15. A method as defined in claim 14, wherein the stored condition communicated to the user is stored on the cloud-based system.

16. A method as defined in claim 1, wherein the image recognition application recognizes the particular product dispenser without using a barcode or a QR code.

17. A system for accessing information regarding a condition of a consumable product dispenser in a washroom facility comprising:
a plurality of product dispensers located within a plurality of washroom facilities wherein each washroom facility includes at least one product dispenser, each product dispenser requiring periodic refill of a consumable product;
at least one sensor configured within each of the product dispensers that detects a condition of the product dispenser, the condition comprising at least one of a product level, a power level, an operating condition, or combinations thereof;
a server system configured to store washroom facility files, each of the washroom facility files being associated with a particular washroom facility of the plurality of washroom facilities, the server system configured to receive information regarding the condition of each product dispenser and configured to store the information, the washroom facility files including the information regarding the condition of each product dispenser; and
an image recognition application loaded onto a mobile device, the image recognition application being configured to recognize a particular product dispenser from the plurality of product dispensers based on receiving optical data related to the particular product dispenser from the mobile device, the image recognition application being in communication with the server system and being configured to communicate to a user the stored condition of the particular product dispenser.

18. A system as defined in claim 17, wherein the image recognition application is configured to recognize a product dispenser based on a shape of the product dispenser.

19. A system as defined in claim 17, wherein the image recognition application is configured to recognize a type of the particular product dispenser and a location of the product dispenser.

20. A system as defined in claim 17, wherein the image recognition application is configured to determine the location of the particular product dispenser by accessing a global positioning system in communication with a mobile device.

21. A system as defined in claim 17, wherein the image recognition application is configured to determine the location of the product dispenser by identifying indicia within the washroom where the product dispenser is located or by determining a location of the user.

22. A system as defined in claim 17, wherein the product dispenser includes an exterior housing and wherein the image recognition application is configured to recognize a product dispenser by the shape of the exterior housing.
